(19) United States
(12) Patent Application Publication
(10) Pub. No.: US 2025/0053989 A1
(43) Pub. Date: Feb. 13, 2025

(54) Virtual Account Use

(71) Applicant: eBay Inc., San Jose, CA (US)

(72) Inventors: Allene Yaplee, San Jose, CA (US); Margaret Zhen Lu, London (GB); Lu Chen, Santa Clara, CA (US); Yelena Drabkin, Los Gatos, CA (US); Vinay Vijay Karkare, San Ramon, CA (US); Prashant Janawade, San Jose, CA (US); Venkata Chaitanya Vasamsetty, Newark, CA (US); Phanisri Kuchibotla, Union City, CA (US); Subbarao Jasti, Mountain House, CA (US); Scottie D. Sharp, San Jose, CA (US); Mohit Kumar, Sunnyvale, CA (US)

(73) Assignee: eBay Inc., San Jose, CA (US)

(21) Appl. No.: 18/930,465

(22) Filed: Oct. 29, 2024

Related U.S. Application Data
(62) Division of application No. 17/587,225, filed on Jan. 28, 2022.
(60) Provisional application No. 63/228,979, filed on Aug. 3, 2021.

(51) Int. Cl. G06Q 20/40; G06Q 20/22; G06Q 30/06

(52) U.S. Cl. CPC G06Q 20/4016; G06Q 20/227; G06Q 30/06

(57) ABSTRACT

Virtual account use in an online marketplace is described. Listings published to a multitude of client devices by the online marketplace include a first listing for a first item and a second listing for a second item. The first item is listed by a first user account and the second item is listed by a second user account. In connection with a third user account purchasing the first item, the online marketplace provides a first monetary compensation to the first user account from the third user account by updating a balance of a virtual account of the first user account to include the first monetary compensation. In connection with the first user account purchasing the second item via the second listing, the online marketplace provides at least a portion of the balance to the second user account directly from the virtual account as second monetary compensation.

### RELATED APPLICATION

This application is a continuation of U.S. application Ser. No. 17/587,225, titled “Virtual Account Use,” filed Jan. 28, 2022, which claims priority under 35 U.S.C. § 119(e) to U.S. Provisional Patent Application No. 63/228,979, filed Aug. 3, 2021 and titled “Stored Value,” the entire disclosure of these applications is hereby incorporated by reference.

### BACKGROUND

Advances in computing technology continue to increase the speed of computing devices and, by extension, many processes implemented by those computing devices. Due at least in part to this speed increase, lag times between various steps of computer-based processes can be reduced, and even effectively eliminated, from the perspective of users. With the continued reduction or elimination of lag times for many of those processes, users become conditioned to expect lag times to be reduced or eliminated for all processes. When a system fails to eliminate the lag times associated with a process, users can become annoyed with the process. Lag times of a given process also affect (e.g., delay) when downstream processes can begin.

With conventional online marketplaces, a seller that sells an item to a buyer is provided with the funds from the sale when those funds are transferred from a financial institution (or instrument) of the buyer to the online marketplace or to a financial institution (or instrument) of the seller. In many scenarios, however, there is lag between when the sale of the item is permitted by a conventional marketplace and when financial systems actually transfers the funds to the seller. In some cases, the lag may be a couple days or longer. Due to the lag between the sale of the item and the availability of funds for the seller, conventional online marketplaces fail to allow funds to be reintroduced into the online economy quickly.

### SUMMARY

To overcome these problems, virtual account use is leveraged in an online marketplace. In one or more implementations, a selection is initially received to opt in a first user account to use a virtual account on the online marketplace, which publishes various listings to a multitude of client devices. In accordance with the described techniques, the listings published by the online marketplace to the client devices include at least a first listing for a first item and a second listing for a second item. The first item is listed on the online marketplace by the first user account and the second item is listed on the online marketplace by a second user account.

In connection with a third user account purchasing the first item via the first listing, the online marketplace provides a first monetary compensation to the first user account from the third user account. In accordance with the described techniques, the online marketplace updates a balance of the first user account's virtual account to include the first monetary compensation, in real-time, as the online marketplace permits the purchase of the first item. The online marketplace permits at least a portion of the updated balance of the virtual account to be immediately available for purchases on the online marketplace by the first user account, even if the online marketplace has not actually received the first monetary compensation. In connection with the first user account purchasing the second item via the second listing, the online marketplace provides at least a portion of the balance to the second user account directly from the virtual account as second monetary compensation.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of the online marketplace of FIG. 1 in greater detail.

FIG. 3 depicts an example of an account summary user interface displaying a user interface instrumentality for opting into virtual account balance use.

FIG. 4 depicts an example of an updated account summary user interface displaying a balance of a virtual account after opting into virtual account balance use.

FIG. 5 depicts an example of a lock screen user interface displaying a notification of a first transaction in which a user account sells an item of a listing to an additional user account for monetary compensation.

FIG. 6 depicts an example of a checkout user interface displaying a summary of a second transaction in which the user account purchases an item of an additional listing from an additional user account for monetary compensation.

FIG. 7 depicts another example of the checkout user interface displaying a prompt for permitting use of a balance of the virtual account for the second transaction, where the balance is updated to include the monetary compensation of the first transaction.

FIG. 8 depicts another example of the checkout user interface displaying application of the balance from the virtual account to the second transaction.

FIG. 9 depicts a procedure in an example implementation of using funds, provided to a user account as part of a first transaction, to facilitate a second transaction by providing the funds directly from the user account.

FIG. 10 depicts a procedure in an example implementation of virtual account use in the online marketplace.

FIG. 11 illustrates an example of a system that includes an example computing device that is representative of one or more computing systems and/or devices that may implement the various techniques described herein.

### DETAILED DESCRIPTION

### Overview

Conventional systems do not allow sellers in an online marketplace to immediately utilize proceeds from their sales to then purchase other items on the online marketplace. As a result, the systems of conventional online marketplaces fail to allow funds to be reintroduced into such marketplaces quickly.

Virtual account use is leveraged in an online marketplace. Use of virtual accounts in an online marketplace enables sellers to use funds directly from their sales to make purchases in an online marketplace without the funds leaving the online marketplace ecosystem. Instead of leveraging a technique where the funds leave the online marketplace ecosystem, in connection with the virtual account use described herein, a balance of a user's funds is maintained by a virtual account within the online marketplace. Due to this, the user's funds from selling items do not need to be “cashed out” or sent as a check in order to be used to make a subsequent purchase on the online marketplace. This balance of the virtual account also enables a user to use the funds without transferring them to or from a digital, cryptographic wallet or to an additional, separate account, such as to an account for making purchases on the online marketplace. In one or more implementations, a selection is initially received to opt in to use a virtual account on the online marketplace. For example, a first user account of the online marketplace opts in to use a virtual account of the online marketplace. Alternatively or in addition, user accounts are set to use the virtual account of the online marketplace without opting in to its use.

In accordance with the described techniques, the online marketplace publishes various listings to a multitude of client devices. The listings published by the online marketplace to the client devices include at least a first listing for a first item and a second listing for a second item. Further, the first item is listed on the online marketplace by the first user account and the second item is listed on the online marketplace by a second user account.

In connection with a third user account purchasing the first item via the first listing, the online marketplace provides a first monetary compensation to the first user account from the third user account. To do so, the online marketplace updates a balance of the first user account's virtual account to include the first monetary compensation, in real-time, as the online marketplace permits the purchase of the first item via the listing. The online marketplace then permits at least a portion of the updated balance of the virtual account to be immediately available for purchases on the online marketplace by the first user account, even if the online marketplace has not actually received the first monetary compensation. In one example, the funds remain in an online marketplace ecosystem such as eBay® without being “cashed out” to the first user account's bank account or sent as a check to an address associated with the first user account. In connection with the first user account purchasing the second item via the second listing, the online marketplace provides at least a portion of the balance to the second user account directly from the virtual account as second monetary compensation.

By using a virtual account for a user rather than waiting for funds to clear a financial institution, the online marketplace eliminates the lag present with transactions of conventional online marketplaces. As a result, the online marketplace also reintroduces funds back into the online marketplace faster than conventional techniques. This allows the online marketplace to facilitate more transactions than conventional online marketplaces. It is to be appreciated that the online marketplace can also make funds available at different times based on a risk level of a seller and/or a buyer, such as prior to or after the transaction is settled and the funds are transferred from the buyer to the seller (e.g., “floated” by the online marketplace).

In addition, the described techniques provide a specific improvement over prior systems, resulting in an improved user interface for electronic devices that facilitate the purchase and sale of items within an ecosystem of a particular online marketplace. This is in part because the described user interface reduces a number of inputs, relative to conventional techniques, that a user must provide in order to purchase an item that is listed on the particular online marketplace when using funds that obtained from selling one or more items on the particular online marketplace. For example, the user interface eliminates user inputs to transfer any funds obtained from a sale to a separate “purchase account” of a user account on the online marketplace, to a bank account or other financial instrument (e.g., credit card or payment service) associated with the user account, and/or to a digital, cryptographic wallet.

Moreover, conventional techniques that involve such transfers can be susceptible to hacking and dependent on local hardware and software, and/or confined to an inflexible one-size-fits-all scheme. In accordance with the described techniques, a first user account is able to use a balance of a respective virtual account to purchase an item listed by a second user account on the online marketplace. In this scenario, the online marketplace updates the balances of both user accounts responsive to the purchase, e.g., decreases the balance of the virtual account of the first user account and increases the balance of the virtual account of the second user account. Further, the second user account is able to use a balance that includes the funds obtained from the above-described transaction to subsequently purchase an item listed by a third user account on the online marketplace

In this scenario, notably, no communication connection needs to be established and maintained by the online marketplace across an interface with an outside source (e.g., to a financial institution associated with one of the user accounts) in order to facilitate the transactions. Connections over such interfaces provide opportunities for hacking, which are eliminated by keeping the execution of the transactions within the online marketplace. Since the described techniques eliminate the need for such connections and for such transfers involving an entity outside a particular marketplace, the virtual account use described herein also reduces network traffic required to execute the described transactions—such as by reducing communications sent over network connections with financial institutions and/or in connection with transferring balances. Additionally, the use of virtual account balances allows an online marketplace to update its underlying systems “behind the scenes” without having to conform to an inflexible one-size-fits-all standard (e.g., communication protocol) implemented by outside sources or destinations of funds.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

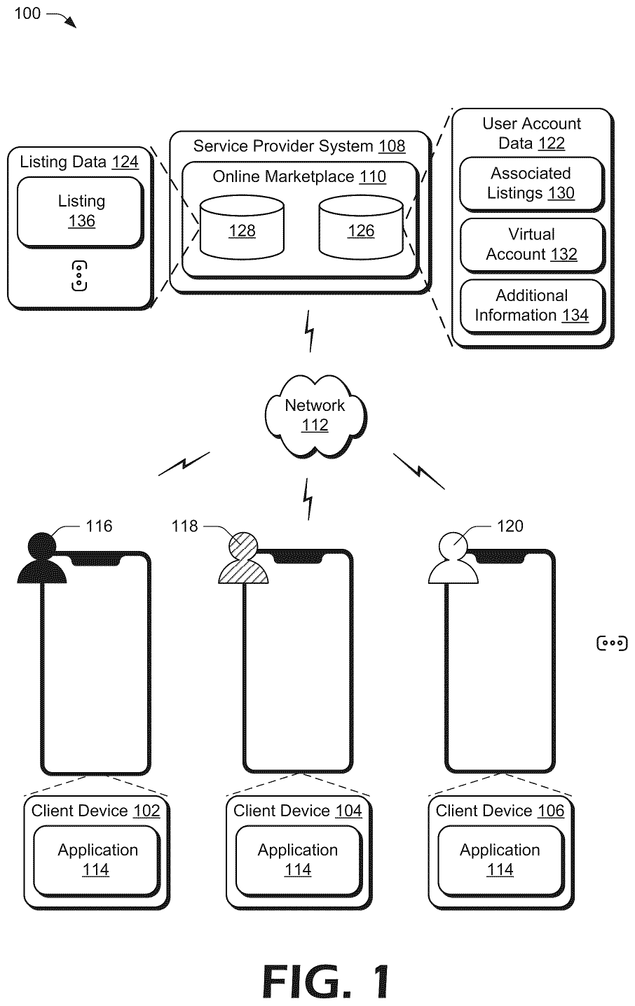

FIG. 1 is an illustration of an environment 100 in an example implementation that is operable to employ techniques described herein. The environment 100 includes a plurality of client devices (represented in the environment by the client device 102, the client device 104, and the client device 106) and a service provider system 108 that provides an online marketplace 110. The plurality of client devices and the service provider system 108 are communicatively coupled, one to another, via a network 112. One example of the network 112 is the Internet, although the plurality of client devices and the service provider system 108 may be communicatively coupled using one or more connections or different networks in various implementations.

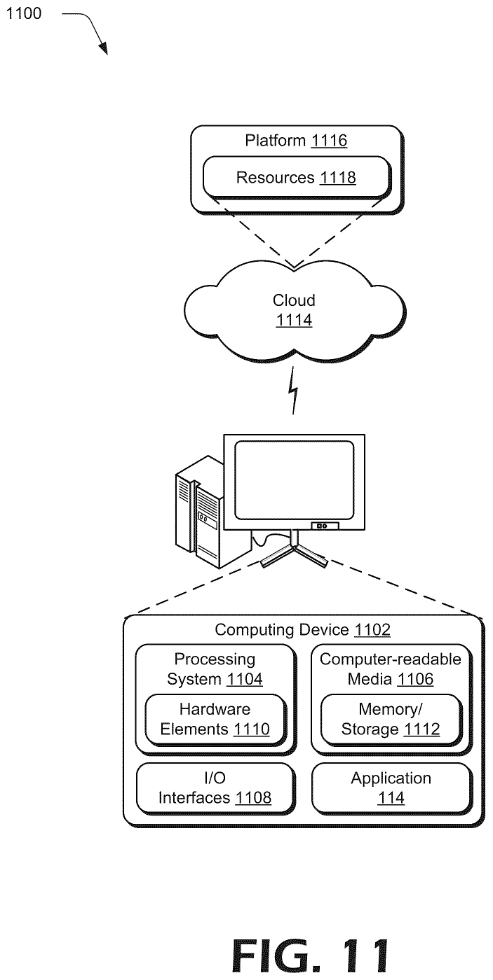

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm utilized to perform operations “over the cloud” as further described in relation to FIG. 11.

In the illustrated example, each of the client devices includes an application 114. In accordance with the described techniques, the application 114 supports communication of data across the network 112 between the client devices and the service provider system 108. By supporting such data communication, the application 114 provides respective users of the client devices access to the online marketplace 110. For example, the client devices receive data from the service provider system 108. Based on the received data, the application 114 causes various systems of a client device to output user interfaces of the online marketplace 110, such as by displaying user interfaces via display devices or making accessible voice-based user interfaces.

Through interaction of a user with a respective client device, the application 114 receives user input via one or more user interfaces of the online marketplace 110. Examples of such input include, but are not limited to, receiving touch input in relation to portions of a displayed user interface, receiving one or more voice commands, receiving typed input (e.g., via a physical or virtual keyboard), receiving mouse or stylus input, and so forth. One example of the application 114 is a browser, which is operable to navigate to a website of the online marketplace 110, display pages of the website, and facilitate user interaction with web pages of the online marketplace 110's website. Another example of the application 114 is a web-based computer application of the online marketplace 110, such as a mobile application or a desktop application. The applications 114 may be separate installations of a same application, e.g., a mobile application of the online marketplace, or may be different applications, e.g., the application 114 of the client device 102 may correspond to a web browser whereas the application of the client device 104 may correspond to a mobile application of the online marketplace 110. The application 114 may be configured in different ways, which enable users to interact with their client devices and by extension perform actions on the online marketplace 110, without departing from the spirit or scope of the techniques described herein.

The illustrated example also depicts representations of user accounts proximate the client devices 102, 104, 106. The representations represent user accounts with the online marketplace 110 that are associated with users of the client devices 102, 104, 106. In particular, the representations represent a first user account 116, a second user account 118, and a third user account 120 of the online marketplace 110. Here, the first user account 116 is associated with the client device 102, the second user account 118 is associated with the client device 104, and the third user account 120 is associated with the client device 106.

In one or more implementations, users register with the service provider system 108 to obtain respective user accounts with the online marketplace 110. Such registration may include, for instance, providing an email address and establishing a username and password combination. Subsequent to registering with the service provider system 108 the client devices facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 110 may be a guest account that does not require a user to sign in or otherwise authenticate to an already established account before interacting with the online marketplace 110.

Broadly speaking, the online marketplace 110 is configured to generate listings for items and to expose those listings (e.g., publish them) to one or more of the client devices. For example, the online marketplace 110 may generate listings for items for sale and expose those listings to the client devices, such that the users of the client devices can interact with the listings via user interfaces to initiate transactions (e.g., purchases, add to wish lists, share, and so on) in relation to the respective item or items of the listings. In accordance with the described techniques, the online marketplace 110 is configured to generate listings for physical goods or property (e.g., collectibles, luxury items, clothing, electronics, real property, physical computer-readable storage having one or more video games stored thereon, and so on), services (e.g., babysitting, dog walking, house cleaning, and so on), digital items (e.g., digital images, digital music, digital videos) that can be downloaded via the network 112, and NFTs, to name just a few.

In the illustrated example, the online marketplace 110 includes user account data 122 and listing data 124 which are shown in storage devices 126, 128, respectively. The storage devices 126, 128 may represent one or more databases and/or other types of storage capable of storing the user account data 122 and the listing data 124. Examples of the storage devices 126, 128 include, but are not limited to, mass storage and virtual storage. In one or more implementations, for example, the storage devices 126, 128 may be virtualized across a plurality of data centers and/or cloud-based storage devices. Although not depicted, the service provider system 108 may implement the online marketplace 110 by using servers that execute stored instructions to deploy various services of the service provider system 108, such that those services perform numerous computations which are effective to provide the functionality described above and below. It is to be appreciated that the online marketplace 110 may include more, fewer, or different components without departing from the spirit or scope described herein.

In accordance with the described techniques, the online marketplace 110 stores the user account data 122 for a plurality of users. Here, the user account data 122 of a single user (e.g., the first user account 116) is depicted for the sake of convenience. It is to be appreciated, however, that the online marketplace 110 includes the user account data 122 for each of the plurality of users of the online marketplace. For example, the online marketplace 110 includes the user account data 122 for the second user account 118, the user account data 122 for the third user account 120, and the user account data 122 for any other user accounts in the online marketplace 110. In this example, the user account data 122 includes data describing associated listings 130, a virtual account 132, and additional information 134. In one or more implementations, the user account data 122 includes more, less, or different data without departing from the spirit or scope of the described techniques.

The online marketplace 110 stores the listing data 124 for a plurality of listings 136. Here, the listing data 124 is depicted including a listing 136 and ellipses which represent additional listings 136. In accordance with the described techniques, each listing 136 corresponds to an item (e.g., a physical good, service, or a digital good) listed on the online marketplace 110. Further, the listing 136 may include a title, a description of one or more items to which the listing 136 corresponds, digital content (e.g., images, videos, AR/VR content, 3D models, etc.) of the one or more items, pricing information, condition information, shipping information, a user account that submits the listing 136 for publication on the online marketplace 110, and so forth. The listing 136 may include different data about a listed item in accordance with the described techniques. The service provider system 108 publishes the listings 136 based on the listing data 124.

Returning to the discussion of the user account data 122, the associated listings 130 describe which of the listings 136 (if any) are associated with a respective user account. For example, the associated listings 130 reference one or more of the listings 136 that are currently listed by the respective user account on the online marketplace 110, e.g., where the items of those listings are currently available for purchase from the respective user account via the online marketplace 110. Alternatively or in addition, the associated listings 130 include historical listings with the online marketplace 110 (e.g., where a transaction for the respective item has been completed or the listing removed) and/or draft listings with the online marketplace 110 (e.g., where the respective user account has begun creating the listing but where the listing has not yet been submitted for publication on the online marketplace 110). Further still, the associated listings 130 may include the listings 136 for which the respective user account is the purchaser of the listed item. Thus, the associated listings 130 may capture a purchase and sale history of the respective user account. The associated listings 130 may include other types of listings 136 without departing from the spirit or scope of the described techniques.

As described above and below, the virtual account 132 includes a balance, which the online marketplace 110 updates based on transactions involving the respective user account. In one or more implementations, the respective user account is required to opt in before the user account is permitted to use the virtual account 132. In scenarios where the respective user account does not opt in to use a virtual account, the online marketplace 110 maintains a balance of funds for the user account. In contrast to the balance of the virtual account 132, though, updates to the balance of a non-virtual account on the online marketplace 110 correspond with times that deposits and withdrawals actually occur—rather than when transactions are simply approved by the online marketplace 110. With a non-virtual account, for instance, its balance is increased when the funds for a transaction are actually received by the online marketplace 110 from a financial institution (e.g., when the funds for the transaction “clear”), and the balance is decreased when the funds are allocated for a purchase by a financial institution. Where the respective user account does not opt in to use a virtual account, funds that are “processing” are not available by the user account for purchasing items listed on the online marketplace 110. Thus, reintroduction of those funds back into the online marketplace 110 is delayed. When the respective user account does opt in to use the virtual account 132, though, at least a portion of funds that are processing are usable by the user account to purchase items listed on the online marketplace 110.

The additional information 134 comprises any of a variety of information that may be associated with the respective user account, including, for example, name, email address, mailing address, password, shipping information, payment information, status as a seller with the online marketplace 110, rating, and so forth. Certainly, the additional information 134 may describe different aspects of the respective user account without departing from the spirit or the scope of the described techniques.

In addition to publishing the listings 136 to client devices, the online marketplace 110 is also configured to facilitate transactions between user accounts, which includes utilizing virtual account balances for any user accounts that have opted into use of a virtual account. By way of example, the online marketplace 110 is configured to facilitate a first transaction between the first user account 116 and the second user account 118. In this example, the first user account 116 has previously opted into use a virtual account. In connection with the first transaction, the first user account 116 sells a first item listed on the online marketplace 110 to the second user account 118 via a first listing 136, and the second user account 118 provides a first monetary compensation to the first user account 116. Responsive to facilitating the transaction, the online marketplace 110 stores at least a portion of the first monetary compensation within the online marketplace 110 in association with the first user account 116, e.g., within the virtual account 132 of the first user account 116.

In contrast to conventional techniques, a balance of the virtual account 132 is updated to include the portion of the first monetary compensation responsive to the online marketplace 110 facilitating the transaction, rather than responsive to a financial institution clearing the first monetary compensation. The online marketplace 110 may also provide the first monetary compensation directly to the virtual account 132 of the first user account 116 directly from the second user account 118 without transfer to an intermediate account associated with the first user account 116. Once the online marketplace 110 permits the first transaction, the balance of the virtual account 132 is immediately available for use by the first user account 116. For example, the balance is immediately available to purchase an item from a different listing on the online marketplace 110 without transfer to any intermediate account. In one or more implementations, the online marketplace 110 updates the balance and makes it available for use by the first user account 116 in real-time as the online marketplace 110 permits the purchase of the first item by the second user account 118. In at least one implementation, a portion of the first monetary compensation is provided to the online marketplace 110 as a fee associated with the first transaction.

Continuing with this example, the online marketplace 110 further facilitates a second transaction between the first user account 116 and the third user account 120. In connection with this second transaction, the third user account 120 sells a second item listed on the online marketplace 110 to the first user account 116 via a second listing 136. Here, the first user account 116 provides a second monetary compensation to the third user account 120. The second monetary compensation at least partially includes funds from the portion of the first monetary compensation stored within the online marketplace, e.g., the second monetary compensation includes at least a portion of the funds within the virtual account 132 of the first user account 116.

In accordance with the described techniques, the funds included in the balance from the portion of the first monetary compensation are provided directly from the virtual account 132 to the third user account 120 without transfer to an intermediate account associated with the first user account 116. In one or more implementations, the online marketplace 110 permits the portion of the balance to be provided to the third user account 120 in connection with the second item before the first monetary compensation is received by the online marketplace 110. Additionally, the online marketplace 110 may facilitate the second transaction before an additional portion of the first monetary compensation (e.g., a held portion) is stored within the online marketplace 110 in association with the first user account 116.

In one or more implementations, the online marketplace 110 supports currency conversion in connection with providing funds directly from a virtual account 132 to another user account, e.g., the third user account 120. For example, the balance of the virtual account 132 of the first user account 116 may correspond to a first currency (e.g., United States Dollar, Euro, Chinese Yuan, Japanese Yen, Bitcoin, Ether, marketplace points, etc.) and the third user account 120 has an account, or also uses a virtual account, that corresponds to a second currency which is different from the first currency. In this example, the online marketplace 110 converts the portion of the balance provided from the first currency to the second currency to update the account of the third user account 120 so that it includes the converted portion in the second currency.

In addition to updating the balance of the virtual account 132 responsive to facilitating transactions, the online marketplace 110 may also update the balance of the virtual account 132 based on additional factors. For instance, the online marketplace 110 may update the balance of the virtual account 132 to include a value of items owned by a respective user account. In one or more implementations, the online marketplace 110 updates the balance of the virtual account 132 to include a value of a least one item listed by the respective user account on the online marketplace 110 or a value of at least one item that the online marketplace 110 verifies is owned by the respective user account.

In a scenario where the online marketplace 110 verifies that the first user account 116 owns a collectible, for instance, the balance of the first user account 116's virtual account 132 may include a value of the collectible. If the first user account 116 uses the portion of the balance tied to the value of the collectible for a transaction, the online marketplace 110 may require the first user account 116 to list the collectible on the online marketplace 110 and the online marketplace 110 may retain the proceeds when another user account purchases the collectible via the listing. Alternatively, the online marketplace 110 may simply initiate transfer of ownership of the collectible from the first user account 116 to the online marketplace 110, e.g., by sending the first user account 116 instructions for shipping the collectible to an address associated with the online marketplace 110. It is to be appreciated that items other than collectibles may serve as a basis for adding to the balance of a respective user account's virtual account 132 without departing from the spirit and the scope of the techniques described herein.

Having considered an example of an environment, consider now a discussion of some example details of the techniques for virtual account use in accordance with one or more implementations.

### Virtual Account Use in an Online Marketplace

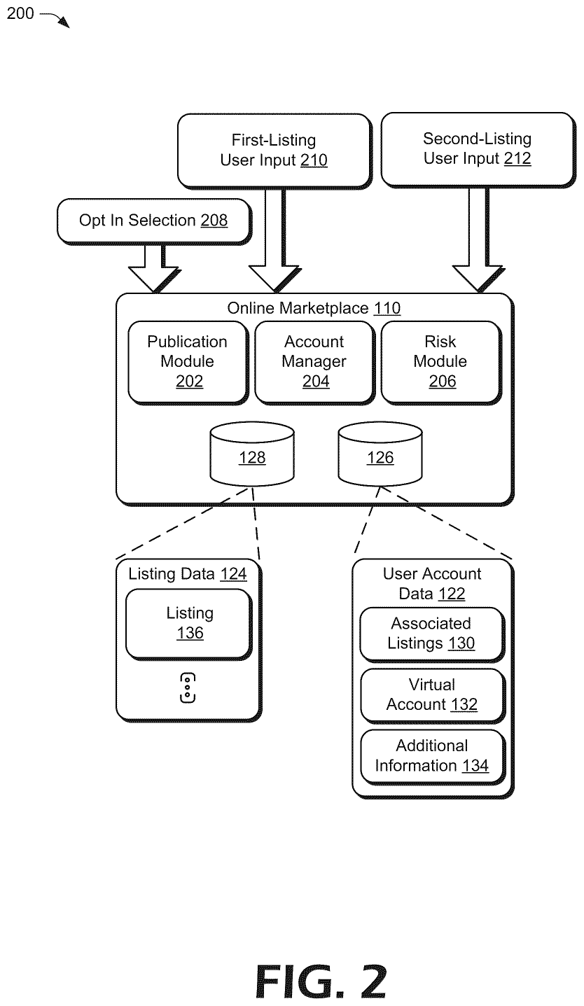

FIG. 2 depicts an example 200 of the online marketplace of FIG. 1 in greater detail. In particular, FIG. 2 includes from FIG. 1 the online marketplace 110 having user account data 122 and the listing data 124.

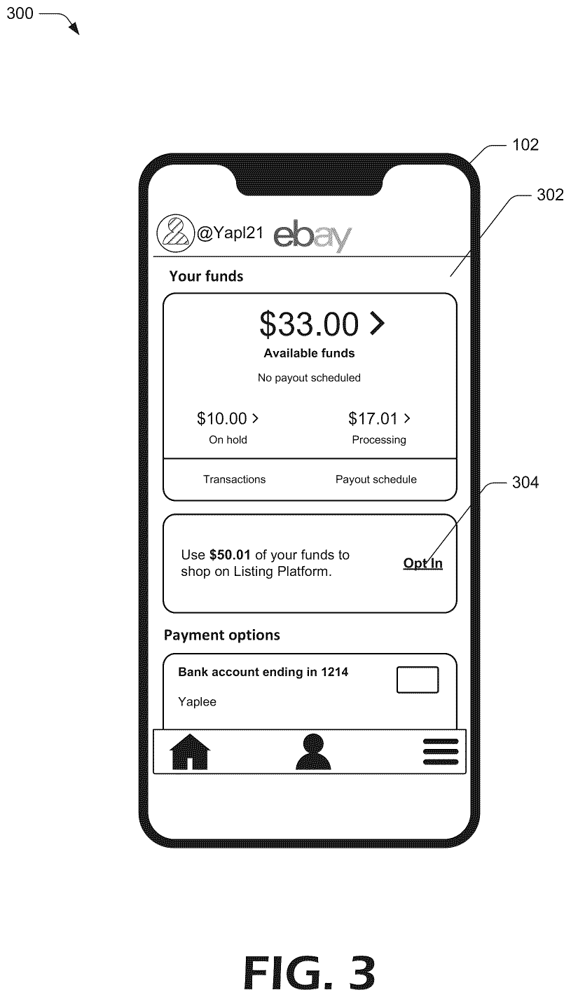

In this example 200, the online marketplace 110 includes publication module 202, account manager 204, and risk module 206. Further, the online marketplace 110 is shown obtaining opt in selection 208, first-listing user input 210, and second-listing user input 212. The opt in selection 208 represents a selection by a user account to opt in to use a virtual account. In one or more implementations, the opt in selection 208 is received via a user interface that presents the option to opt in to use the virtual account 132. For instance, a user interface displays a graphical user interface element that is selectable by a user (e.g., via touch input) to opt the respective user account in to use the virtual account 132. An example of a user interface that displays an element that is selectable to opt in to use the virtual account 132 is discussed in more detail in relation to FIG. 3.

The first-listing user input 210 represents user input received via a user interface of the online marketplace 110 to initiate a transaction for an item listed by a first listing 136, e.g., which lists a first physical good, service, or digital good. For example, the first-listing user input 210 corresponds to user input (e.g., a touch input) received by a client device in relation to a “Confirm and pay” or “Buy Now” button displayed in connection with the first listing 136 for purchasing the first good or service. Similarly, the second-listing user input 212 represents user input received via a user interface of the online marketplace 110 to initiate a transaction for an item listed by a second listing 136, e.g., which lists a second physical good, service, or digital good. For example, the second-listing user input 212 corresponds to user input (e.g., a touch input) received by a client device in relation to a “Confirm and pay” or “Buy Now” button displayed in connection with the second listing 136 for purchasing the second good or service. In accordance with the described techniques, the second-listing user input 212 is received subsequent to receipt of the first-listing user input 210.

In accordance with the described techniques, the publication module 202 uses the listing data 124 to publish the listings 136 via the network 112 to the plurality of client devices. For instance, the publication module 202 causes the listings to be exposed so that the client devices can be used to navigate to the listings 136, browse the listings 136, search the listings 136, interact with the listings 136, and so on.

Consider an example in which the publication module 202 publishes a first listing 136 for a first item and a second listing 136 for a second item to the plurality of client devices. In this example, the first user account 116 may list the first item on the online marketplace 110, such that the associated listings 130 of the first user account 116 indicate that the first listing 136 is associated with the first user account 116. Also in this example, the second user account 118 may list the second item on the online marketplace 110, such that the associated listings 130 of the second user account 118 indicate that the second listing 136 is associated with the second user account 118.

The account manager 204 manages balances based on transactions facilitated by the online marketplace 110. This includes updating balances of virtual accounts responsive to the online marketplace 110 facilitating transactions via the listings 136. The account manager 204 is also configured to manage the actual transfer of monetary compensation in one or more implementations, such as by obtaining monetary compensation from a financial institution that corresponds to a transaction and/or providing monetary compensation to a financial institution based on a transaction. In scenarios where users opt in to use a virtual account, the account manager 204 may update the virtual accounts such that a timing of an update does not match an underlying transfer of monetary compensation to or from a financial institution. In those scenarios, the account manager 204 updates the virtual accounts of opted in user accounts responsive to the online marketplace 110 facilitating transactions. By way of contrast, the account manager 204 may update available funds for user accounts that have not opted in to use the virtual account such that the updates correspond to (or are subsequent to) occurrence of the underlying transfer of monetary compensation to or from a financial institution.

Consider again the scenario where the first user account 116 lists the first item on the online marketplace 110 via a first listing 136 and the second user account 118 lists the second item on the online marketplace 110 via a second listing 136. Consider also that the first-listing user input 210 is received based on a selection of the third user account 120 to purchase the first item via the first listing 136, e.g., the user associated with the third user account 120 selects a “Confirm and pay” or “Buy Now” button in relation to the first listing 136. When the first user account 116 has opted in to use a virtual account, the account manager 204 provides first monetary compensation to the first user account 116 from the third user account 120 by updating the balance of the first user account 116's virtual account 132 to include the first monetary compensation. In accordance with the described techniques, the account manager 204 updates the balance of the virtual account 132 such that the balance is available in real-time as the online marketplace 110 permits the purchase of the first item by the third user account 120. In other words, the balance of the virtual account 132 is immediately available for use by the first user account 116 to purchase other items on the online marketplace, such as items of other listings 136 published by the publication module 202.

In the continuing example, the second-listing user input 212 is received after the account manager 204 updates the virtual account 132. For instance, the second-listing user input 212 is received based on a selection of the first user account 116 to purchase the second item via the second listing 136, e.g., the user associated with the first user account 116 selects a “Confirm and pay” or “Buy Now” button in relation to the second listing 136. When the first user account 116 has opted in to use a virtual account, the account manager 204 provides at least a portion of the balance of the first user account 116's virtual account 132 to the second user account 118 directly from the virtual account 132 as second monetary compensation. The account manager 204 then updates the balance of the first user account 116's virtual account 132 by reducing it by the portion provided to the second user account 118.

In one or more implementations, the account manager 204 provides the portion of the balance to the second user account 118 directly from the virtual account 132 without transferring the portion to any intermediate account associated with the first user account 116. In at least some variations, the account manager 204 holds a portion of the monetary compensation associated with a purchase before releasing the portion to be included as part of a balance of the virtual account 132. For instance, the account manager 204 may hold a portion of the monetary compensation until after the above-mentioned first monetary compensation is provided to the first user account 116. The account manager 204 may then provide the held portion of the monetary compensation to the first user account 116, subsequent to being held, by further updating the balance of the virtual account 132 to include the held portion. In one or more implementations, a portion of the monetary compensation is held based on risk associated with at least one of the user accounts involved in the transaction, e.g., the seller or the buyer.

The risk module 206 determines risk associated with user accounts. The risk module 206 may also prohibit access to at least a portion of monetary compensation based on determined risk for a period of time, such as until after a transaction is settled. Alternatively, the risk module 206 may provide limits to the account manager 204, which cause the account manager 204 to limit an amount of a virtual account 132's balance that is available for purchasing items listed by the online marketplace 110. Such limits may also be based on the risk determined by the risk module 206.

In connection with the continuing example, for instance, the risk module 206 is configured to determine at least one of a first risk level associated with the first user account 116 or a second risk level associated with the second user account 118 (and is configured to determine risk levels for other user accounts). Based on at least one of the first risk level or the second risk level, the account manager 204 provides the first user account 116 access to a portion of the first monetary compensation for the first item at a time following the transaction.

Alternatively or in addition, the risk module 206 compares at least one of the first risk level or the second risk level to a threshold risk level. Responsive to the risk module 206 determining that at least one of the first risk level or the second risk level is greater than the threshold risk level based on the comparing, the account manager 204 may provide the first user account 116 with access to a portion of the monetary compensation after the first transaction is settled between the first user account and the second user account. Responsive to the risk module 206 determining that at least one of the first risk level or the second risk level is less than the threshold risk level based on the comparing, the account manager 204 may provide the first user account 116 with access to the portion of the monetary compensation before the first transaction is settled between the first user account 116 and the second user account 118.

FIGS. 3-8 depict user interfaces displayed in connection with using a virtual account. In particular, those figures depict and the following discussion describes an example use of a virtual account from the perspective of the first user account 116, such that the user interfaces are displayed by the client device 102 associated with the first user account 116.

FIG. 3 depicts an example 300 of an account summary user interface displaying a user interface instrumentality for opting into virtual account balance use.

The illustrated example 300 includes the client device 102 of FIG. 1, which is depicted displaying account summary user interface 302. The account summary user interface 302 depicts a summary of the user account of the first user account 116 prior to opting into use of a virtual account. In addition, the account summary user interface 302 includes selectable user interface instrumentality 304. The selectable user interface instrumentality 304 is selectable by a user of the client device 102 to opt the first user account 116 in to using a virtual account (or initiate a series of user interfaces to opt in to use a virtual account). By selecting the selectable user interface instrumentality 304, for example, the online marketplace 110 receives the opt in selection 208 for the first user account 116.

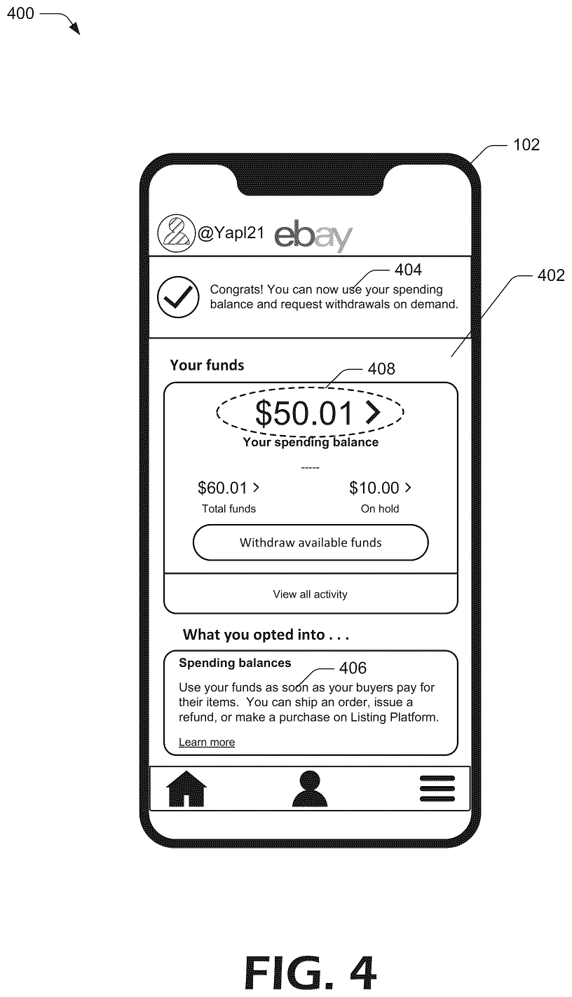

FIG. 4 depicts an example 400 of an updated account summary user interface displaying a balance of a virtual account after opting into virtual account balance use.

The illustrated example 400 includes the client device 102 of FIG. 1, which is depicted displaying an updated account summary user interface 402. The online marketplace 110 may cause the updated account summary user interface 402 to be displayed responsive to the receiving the opt in selection 208. The updated account summary user interface 402 displays a first message 404 describing that by opting in to use of the virtual account, the first user account 116 can use the balance of the respective virtual account 132 and request withdrawals (e.g., to a bank account) from the balance on demand. In addition to requesting withdrawals to a bank account, in one or more implementations, the user account 116 can request withdrawals from the balance to other sources, such as to physical retailers, other online marketplaces or retailers, a financial instrument of the online marketplace 110 (e.g., a debit card or gift card issued by the online marketplace 110), as currency from an automated teller machine, or as an electronic funds transfer to a retailer (e.g., grocery store), to name just a few. The updated account summary user interface 402 also displays a second message 406 describing that by opting in to use of the virtual account, the first user account 116 can use funds as soon as buyers select to pay for their items, e.g., via a listing of the first user account 116. By way of contrast to the “Available funds” of the account summary user interface 302, the display of the virtual account balance 408 presented on the updated account summary user interface 402 includes the amount that is “Processing” from the account summary user interface 302.

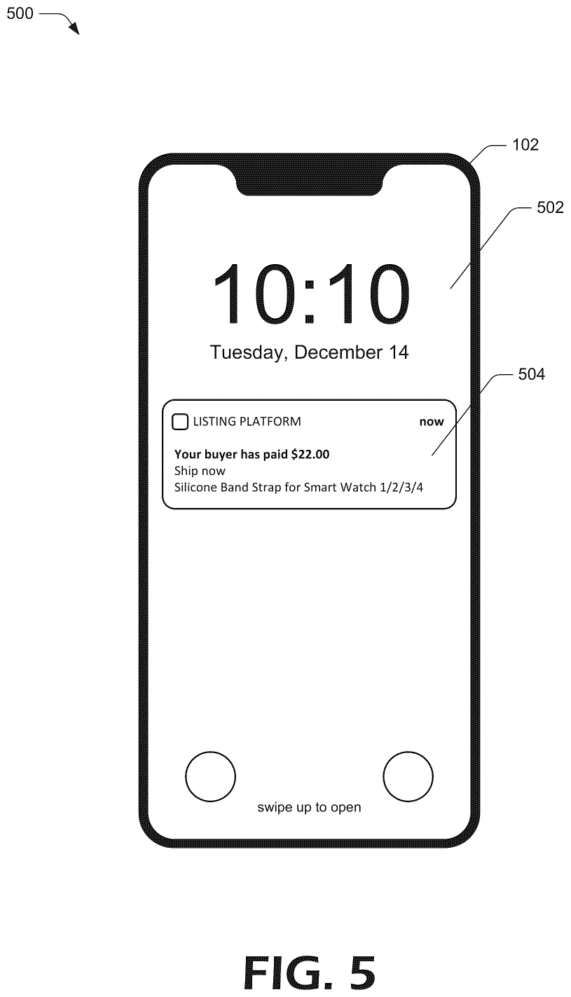

FIG. 5 depicts an example 500 of a lock screen user interface displaying a notification of a first transaction in which a user account sells an item of a listing to an additional user account for monetary compensation.

The illustrated example 500 includes the client device 102 of FIG. 1, which is depicted displaying a lock screen user interface 502. Here, the lock screen user interface 502 is depicted displaying transaction notification 504. The transaction notification 504 is displayed to notify a user associated with the client device 102 that the first user account 116 has sold an item of a listing to an additional user for monetary compensation. For example, the online marketplace 110 may cause the application 114 to display the transaction notification 504 responsive to receiving the first-listing user input 210.

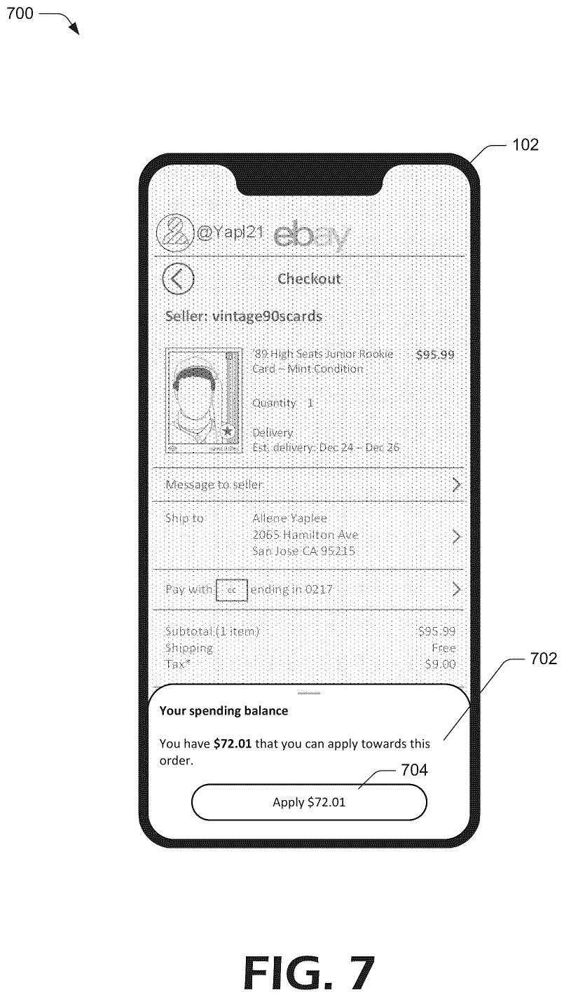

In this example, the online marketplace 110 may receive the first-listing user input 210 responsive to a user associated with the second user account 118 selecting to purchase an item listed by the first user account 116 on the online marketplace 110. In connection with the transaction notification 504, the account manager 204 updates the balance of the first user account 116's virtual account 132 to include the monetary compensation of the respective transaction. The balance, as updated based on the respective transaction, is depicted in FIG. 7, e.g., the updated balance includes the balance of $50.01 depicted in the updated account summary user interface 402 and the $22.00 amount indicated in the transaction notification 504.

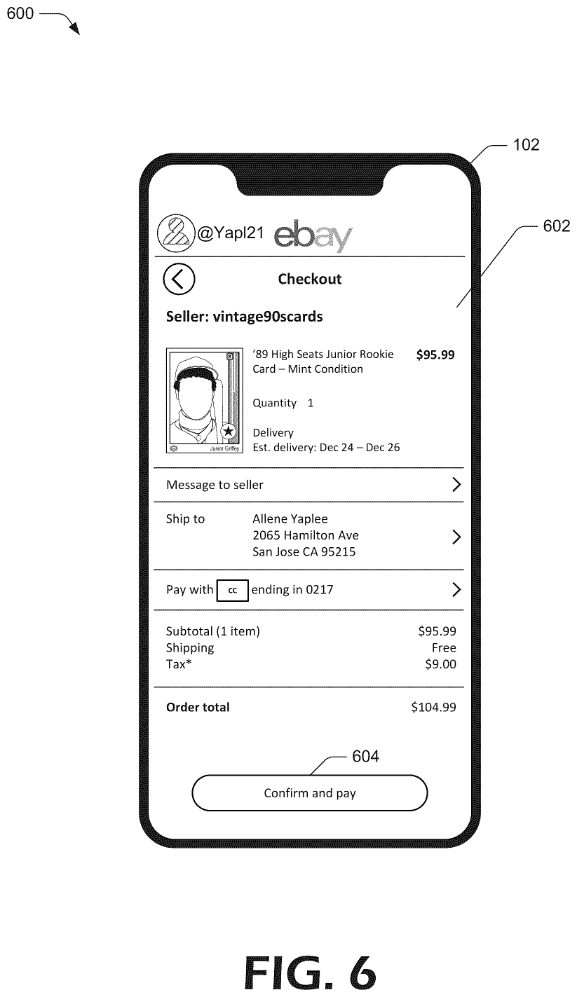

FIG. 6 depicts an example 600 of a checkout user interface displaying a summary of a second transaction in which the user account purchases an item of an additional listing from an additional user account for monetary compensation.

The illustrated example 600 includes the client device 102 of FIG. 1, which is depicted displaying a checkout user interface 602. The checkout user interface 602 includes a summary of a second transaction. With the second transaction, the first user account 116 purchases an item of an additional listing from an additional user account for monetary compensation. For example, the first user account 116 initiates purchase of an item from the third user account 120, namely, the item included in the checkout user interface 602. In accordance with the described techniques, the first user account 116 initiates a purchase of the item via a respective listing for monetary compensation. The checkout user interface 602 also includes a transaction submission instrumentality 604, which is selectable by a user of the client device to cause the online marketplace 110 to facilitate the second transaction. In the context of FIG. 2, the online marketplace 110 receives the second-listing user input 212 responsive to selection of the transaction submission instrumentality 604. In the context of enabling the first user account 116 to use the balance of the virtual account 132 for purchase of the second item, consider the following discussion.

FIG. 7 depicts another example 700 of the checkout user interface displaying a prompt for permitting use of a balance of the virtual account for the second transaction, where the balance is updated to include the monetary compensation of the first transaction.

The illustrated example 700 includes the client device 102 of FIG. 1, which is depicted displaying a prompt 702 for permitting the first user account 116 to use the balance of the virtual account 132 for the second transaction. In the illustrated example 700, the prompt 702 also displays the balance of the first user account 116's virtual account 132. As illustrated, the balance has been updated in this example to include the monetary compensation of the first transaction, e.g., the transaction discussed in relation to FIG. 5. As noted in the discussion of FIG. 5, the updated balance includes both the balance of $50.01 depicted in the updated account summary user interface 402 and the $22.00 amount indicated in the transaction notification 504 for the first transaction, resulting in a total balance of $72.01.

The prompt 702 may be displayed responsive to various events. For example, the prompt 702 may be displayed responsive to a user of the client device 102 selecting the transaction submission instrumentality 604 or responsive to a user of the client device providing input in relation to a different portion of the checkout user interface 602. Certainly, the online marketplace 110 may enable a user account to apply at least a portion of a virtual account 132's balance toward a purchase of an item listed on the online marketplace 110 in different ways without departing from the spirit or scope of the described techniques.

Regardless, a user of the client device 102 selects to use the balance, or a portion of the balance, of the virtual account 132 for purchasing an item from a listing on the online marketplace 110. Here, the prompt 702 includes a balance application instrumentality 704. Thus, the user of the client device 102 may select the balance application instrumentality 704 to use at least a portion of the balance of the virtual account 132 for purchasing an item from a listing on the online marketplace 110.

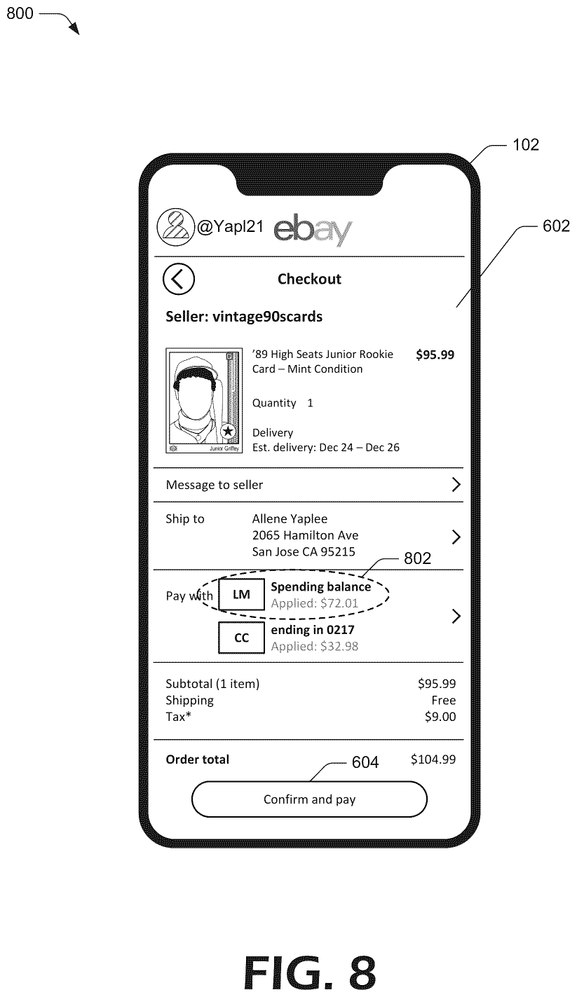

FIG. 8 depicts another example 800 of the checkout user interface displaying application of the balance from the virtual account to the second transaction.

The illustrated example 800 includes the client device 102 of FIG. 1, which is depicted again displaying the checkout user interface 602. In this example 800, however, the checkout user interface 602 displays an indication 802, which indicates a portion of the virtual account 132's balance that is used for the second transaction. Here, the checkout user interface 602 indicates that the balance of the first user account 116's virtual account 132 and an additional monetary compensation method are used for the second transaction, e.g., to purchase the second item via from the third user account 120.

It is to be appreciated that the online marketplace 110 supports use of the balance of the virtual account 132 along with one or more concurrent forms of monetary compensation, in one or more implementations. In connection with a transaction for a particular item, for instance, the online marketplace 110 supports use of at least a portion of the balance of the virtual account 132 along with one or more additional, concurrent forms of monetary compensation such as, debit cards, credit cards, gift cards or codes, coupons, payment services, digital cryptographic wallets, and so forth. The online marketplace 110 is also capable of updating the balance of a virtual account 132 for a user account that sells an item independent of settlement timing and/or strategy of each concurrent form of payment used to purchase the item from the seller.

Having discussed exemplary details of virtual account use in an online marketplace, consider now some examples of procedures to illustrate additional aspects of the techniques.

### Example Procedures

This section describes examples of procedures for virtual account use in an online marketplace. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

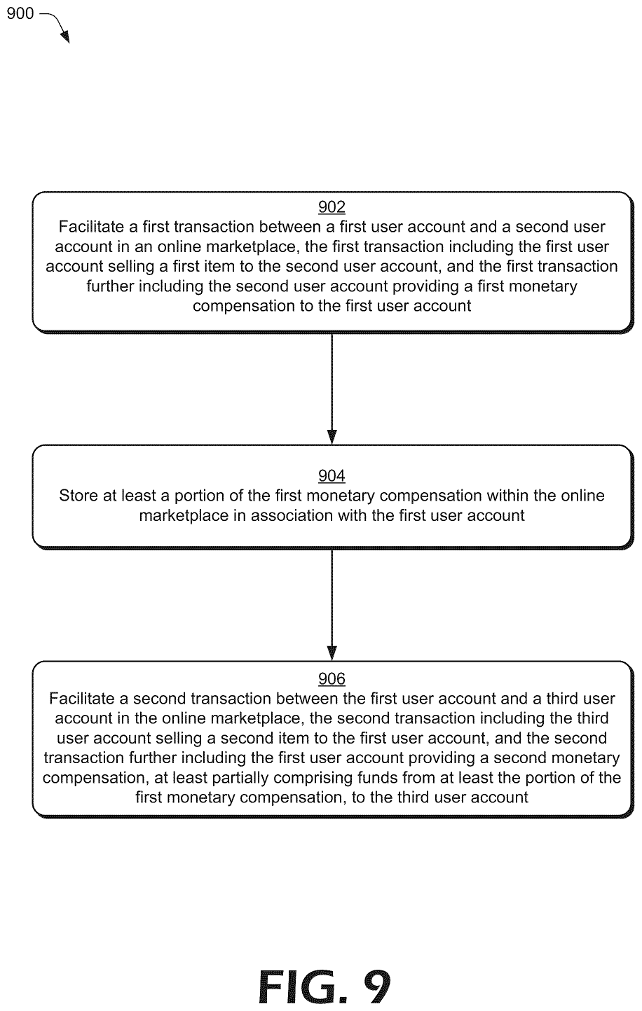

FIG. 9 depicts a procedure 900 in an example implementation of using funds, provided to a user account as part of a first transaction, to facilitate a second transaction by providing the funds directly from the user account.

A first transaction is facilitated between a first user account and a second user account in an online marketplace (block 902). In accordance with the principles discussed herein, the first transaction includes the first user account selling a first item to the second user account and includes the second user account providing a first monetary compensation to the first user account. By way of example, the online marketplace 110 facilitates a first transaction that is between the first user account 116 and the second user account 118. The first transaction includes the first user account 116 selling a first item via a respective listing 136 to the second user account 118. The first transaction further includes the second user account 118 providing a first monetary compensation to the first user account 116.

At least a portion of the first monetary compensation is stored within the online marketplace in association with the first user account (block 904). By way of example, the online marketplace 110 stores at least a portion of the first monetary compensation, provided by the second user account 118 to the first user account 116, in the virtual account 132 of the first user account 116.

A second transaction is facilitated between the first user account and a third user account in the online marketplace (block 906). In accordance with the principles discussed herein, the second transaction includes the third user account selling a second item to the first user account and includes the first user account providing a second monetary compensation, at least partially comprising funds from at least the portion of the first monetary compensation, to the third user account. By way of example, the online marketplace 110 facilitates a second transaction that is between the first user account 116 and the third user account 120. The second transaction includes the third user account 120 selling a second item to the first user account 116. The second transaction further includes the first user account 116 providing a second monetary compensation to the third user account 120, where the second monetary compensation at least partially comprises funds from at least the portion of the first monetary compensation.

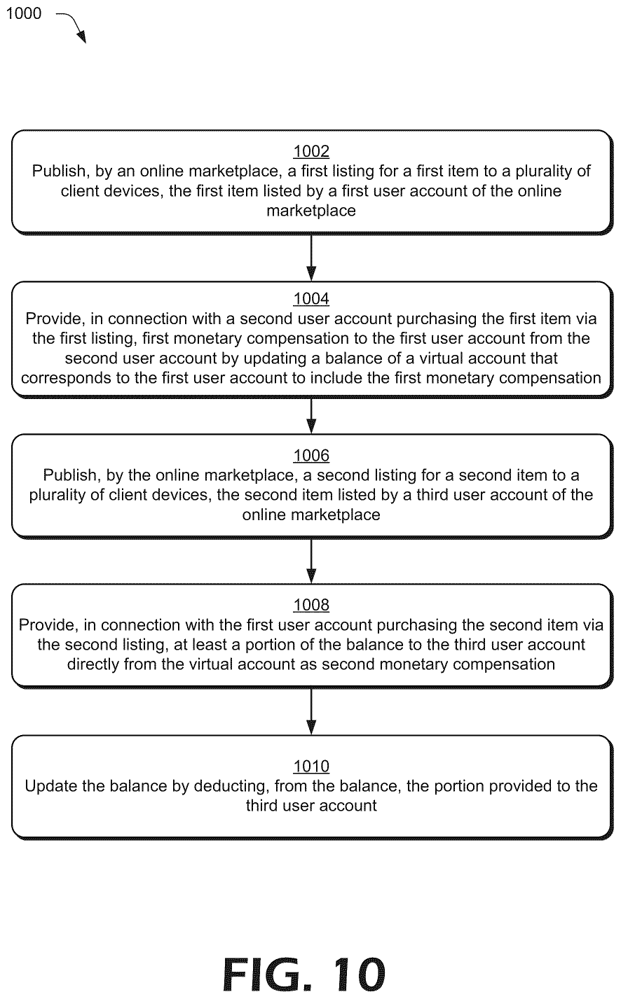

FIG. 10 depicts a procedure 1000 in an example implementation of virtual account use.

A first listing for a first item is published to a plurality of client devices by an online marketplace (block 1002). In accordance with the principles discussed herein, the first item is listed on the online marketplace by a first user account of the online marketplace. The online marketplace 110 publishes a first listing 136 for a first item to a plurality of client devices, e.g., including the client devices 102, 104, 106. The first listing 136 is listed on the online marketplace 110 by the first user account 116. For instance, the associated listings 130 of the first user account 116 associate the first listing 136 with the first user account 116, e.g., as the seller.

First monetary compensation is provided to the first user account from a second user account in connection with the second user account purchasing the first item via the first listing (block 1004). In accordance with the principles discussed herein, the first monetary compensation is provided by updating a balance of a virtual account that corresponds to the first user account to include the first monetary compensation. By way of example, a first monetary compensation is provided to the first user account 116 from the second user account 118 in connection with the second user account 118 purchasing the first item via the first listing 136. In particular, the online marketplace 110 provides the first monetary compensation by updating the balance of the first user account 116's virtual account 132 to include the first monetary compensation.

A second listing for a second item is published to the plurality of client devices by the online marketplace (block 1006). In accordance with the described techniques, the second item is listed on the online marketplace by a third user account of the online marketplace. By way of example, the online marketplace 110 publishes a second listing 136 for a second item to a plurality of client devices, e.g., including the client devices 102, 104, 106. The second listing 136 is listed on the online marketplace 110 by the third user account 120. For instance, the associated listings 130 of the third user account 120 associate the second listing 136 with the third user account 120, e.g., as the seller.

At least a portion of the balance is provided, in connection with the first user purchasing the second item via the second listing, to the third user account directly from the virtual account as second monetary compensation (block 1008). By way of example, the online marketplace 110 provides at least a portion of the balance of the first user account 116's virtual account 132 to the third user account 120 directly from the virtual account 132 as second monetary compensation. The second monetary compensation is provided in connection with the first user account 116 purchasing the second item via the second listing 136.

The balance is updated by deducting, from the balance, the portion provided to the third user account (block 1010). By way of example, the online marketplace 110 updates the balance of the first user account 116's virtual account 132 by deducting the portion provided to the third user account 120 in connection with the second transaction.

Having described examples of procedures in accordance with one or more implementations, consider now an example of a system and device that can be utilized to implement the various techniques described herein.

### Example System and Device

FIG. 11 illustrates an example of a system generally at 1100 that includes an example of a computing device 1102 that is representative of one or more computing systems and/or devices that may implement the various techniques described herein. This is illustrated through inclusion of the application 114. The computing device 1102 may be, for example, a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware elements 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of a module that is executable by the computing device 1102 as software may be achieved at least partially in hardware, e.g., through use of computer-readable storage media and/or hardware elements 1110 of the processing system 1104. The instructions and/or functions may be executable/operable by one or more articles of manufacture (for example, one or more computing devices 1102 and/or processing systems 1104) to implement techniques, modules, and examples described herein.

The techniques described herein may be supported by various configurations of the computing device 1102 and are not limited to the specific examples of the techniques described herein. This functionality may also be implemented all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 may include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 may abstract resources and functions to connect the computing device 1102 with other computing devices. The platform 1116 may also serve to abstract scaling of resources to provide a corresponding level of scale to encountered demand for the resources 1118 that are implemented via the platform 1116. Accordingly, in an interconnected device embodiment, implementation of functionality described herein may be distributed throughout the system 1100. For example, the functionality may be implemented in part on the computing device 1102 as well as via the platform 1116 that abstracts the functionality of the cloud 1114.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A method comprising:
publishing, by an online marketplace, a first listing for a first item to a plurality of client devices, the first item listed by a first user account of the online marketplace;
providing, in connection with a second user account purchasing the first item via the first listing, first monetary compensation to the first user account from the second user account by updating a balance of a virtual account that corresponds to the first user account to include the first monetary compensation;
publishing, by the online marketplace, a second listing for a second item to a plurality of client devices, the second item listed by a third user account of the online marketplace; and
providing, in connection with the first user account purchasing the second item via the second listing, at least a portion of the balance to the third user account directly from the virtual account as second monetary compensation.

2. The method of claim 1, wherein the balance is updated and available for use by the first user account in real-time as the online marketplace permits purchase of the first item.

3. The method of claim 1, further comprising permitting at least the portion of the balance to be provided to the third user account in connection with purchase of the second item before the first monetary compensation is received by the online marketplace.

4. The method of claim 1, further comprising further updating the balance to include a value of at least a third item listed by the first user account via the online marketplace.

5. The method of claim 4, wherein the third item is a collectible.

6. The method of claim 1, wherein at least the portion of the balance is provided to the third user account directly from the virtual account without transferring at least the portion of the balance to any intermediate account associated with the first user account.

7. The method of claim 1, further comprising providing a third monetary compensation to the first user account from the second user account in connection with purchasing the first item, the third monetary compensation being held by the online marketplace until after the first monetary compensation is provided to the first user account, and the third monetary compensation being provided to the first user account subsequent to being held by further updating the balance of the virtual account to include the third monetary compensation.

8. The method of claim 7, wherein the third monetary compensation is held by the online marketplace based on risk associated with at least one of the first user account or the second user account.

9. The method of claim 7, further comprising limiting an amount of the balance that is available for use by the first user account for purchasing items listed by the online marketplace.

10. A system comprising:
at least one storage device to store a plurality of listings for items listed on an online marketplace, the plurality of listings including at least a first listing for a first item and a second listing for a second item, the first item listed by a first user account of the online marketplace and the second item listed by a second user account of the online marketplace; and
at least one server device storing instructions that are executable by a processer to cause the at least one server device to:
publish the plurality of listings via the online marketplace;
provide, in connection with a third user account purchasing the first item via the first listing, first monetary compensation to the first user account from the third user account by updating a balance of a virtual account that corresponds to the first user account to include the first monetary compensation; and
provide, in connection with the first user account purchasing the second item via the second listing, at least a portion of the balance to the second user account directly from the virtual account as second monetary compensation.

11. A method comprising:
displaying, via a first user interface of an online marketplace, a graphical user interface element comprising an option to opt in to use a virtual account;
in response to receiving input selecting the option to opt in a first user account to use a virtual account, permitting the first user account to use a first virtual account on the online marketplace, the first virtual account maintaining funds for use within the online marketplace by the first user account;
in response to receiving input to list a first item on the online marketplace for the first user account, publishing a listing for the first item on the online marketplace, the listing for the first item including a first selectable button to purchase the first item from the first user account;
in response to input by a second user account to the first selectable button, facilitating a first transaction between the second user account and the first user account, including:
transferring ownership of the first item to the second user account; and
providing a first monetary compensation from the second user account to the first virtual account of the first user account directly;
in response to the first transaction, displaying, via a second user interface of the online marketplace and in real-time, a balance of the first monetary compensation that is available to the first user account for immediate use within the online marketplace to purchase a second item listed on the online marketplace from a third user account; and
in response to input by the first user account to a second selectable button to purchase the second item from the third user account, displaying a prompt that is selectable by the first user account to use the balance immediately for purchasing the second item from the third user account without transfer to an intermediate account.

12. The method of claim 11, further comprising:
determining a first risk level associated with the first user account or a second risk level associated with the second user account; and
providing the first user account with access to the balance of the first monetary compensation that is available to the first user account for immediate use at a time following the first transaction based on the first risk level or the second risk level.

13. The method of claim 12, further comprising:
comparing the first risk level or the second risk level to a threshold risk level; and
responsive to the first risk level or the second risk level being greater than the threshold risk level, providing the first user account with access to the balance of the first monetary compensation that is available to the first user account for immediate use after the first transaction is settled between the first user account and the second user account.

14. The method of claim 12, further comprising:
comparing the first risk level or the second risk level to a threshold risk level; and
responsive to the first risk level or the second risk level being less than the threshold risk level, providing the first user account with access to the balance of the first monetary compensation that is available to the first user account for immediate use prior to the first transaction being settled between the first user account and the second user account.

15. The method of claim 11, wherein a portion of the first monetary compensation is provided to the online marketplace as a fee associated with the first transaction.

16. The method of claim 11, wherein the first item is a first physical good or a first service and the second item is a second physical good or a second service.

17. The method of claim 11, further comprising facilitating a second transaction between the first user account and the third user account for the second item before a remaining balance of the first monetary compensation is stored within the online marketplace in association with the first user account.

18. The method of claim 11, further comprising, displaying, via a checkout user interface of an application of the online marketplace, both a summary of a second transaction between the first user account and the third user account for the second item and the prompt that is selectable by the first user account to use the balance immediately for purchasing the second item.

19. The method of claim 11, wherein the balance of the first monetary compensation that is available to the first user account for immediate use is displayed at a time that does not match an underlying transfer of monetary compensation for the first transaction involving at least one financial institution associated with the first user account and the second user account.

20. The method of claim 11, wherein the first user interface of the online marketplace is displayed via an application of the online marketplace, and the method further comprises at least one of:
receiving the input selecting the option to opt in a first user account to use a virtual user account via a user interface of the application of the online marketplace; or
receiving the input to list the first item on the online marketplace for the first user account via a user interface of the application of the online marketplace.
